(19) United States
(12) Patent Application Publication
(10) Pub. No.: US 2001/0016154 A1
(43) Pub. Date: Aug. 23, 2001

(54) FLEXIBLE VEHICLE WHEELNUT LOCKING DEVICE

(76) Inventors: HANNU LAAKKONEN, NURMES (FI); MARTTI LAAKKONEN, NURMES (FI)

Correspondence Address: CUSHMAN DARBY & CUSHMAN, PILLSBURY MADISON & SUTRO LLP, 1100 NEW YORK AVE NW, NINTH FLOOR EAST TOWER, WASHINGTON, DC, 200053918

(21) Appl. No.: 09/357,131

(22) Filed: Jul. 20, 1999

Related U.S. Application Data
(63) Continuation of application No. PCT/FI98/00047, filed on Jan. 21, 1998.

(30) Foreign Application Priority Data
Jan. 21, 1997 (FI) U970029

(51) Int. Cl. F16B 39/04

(52) U.S. Cl. 411/87

(57) ABSTRACT

The object of the invention is a vehicle wheelnut locking device, which comprises a body comprising two or more locking parts and one or more center sections between the locking parts, in locking parts are formed holes which are arranged to be positioned around the nuts of a wheel to prevent them rotating, and the locking device is manufactured at least partly from a flexible material.

The subject of the invention is a vehicle wheelnut locking device which comprises a body comprising two or more locking parts in which are formed holes and one or more center sections between the locking parts, which holes are positioned around the nuts of a wheel to prevent them rotating.

Vehicle wheels are usually attached by several wheelnuts to the hub. Whilst driving, these nuts can work loose and gradually unscrew themselves. In this situation, there is a danger that the wheel of the vehicle can detach itself. This can cause a serious accident. When a wheel comes off, the driver loses control of the vehicle and the vehicle and driver can be damaged or injured, and other road users are also endangered. In addition, the loose wheel can cause damage or a dangerous situation by coming off and travelling on its own at high speed. The loosening of wheelnuts and the possible loss of a wheel is a particularly serious problem with heavy commercial vehicles such as lorries, articulated lorries, and buses, where the wheels are large and heavy. Wheels coming loose from other types of vehicle can also cause an accident. Sometimes an accident can also be caused by the wheelnut coming away from the wheel.

In documents EP 353017, GB 229421, U.S. Pat. No. 3,741,603 and U.S. Pat. No. 4,737,057 has been presented different kind of locking devices. All these locking devices are manufactured of metal or something stiff material. So they can note move at all. However the wheelnuts became longer when the temperature rises and so the wheelnuts can slack and they are not tightly stretched against the rims of the wheel. This can cause damages of rims and nuts although there are locking devices.

The purpose of this invention is to introduce a vehicle wheelnut locking device which removes the aforementioned problems. In particular, the purpose of this invention is to introduce a vehicle wheelnut locking device with which the nuts on the wheel can be reliably and safely locked in position, prevented from unscrewing and noticed when the wheelnuts are not tightly enough. In addition, the purpose of this invention is to introduce a locking device that has a simple construction, is easy to use and can be economically produced.

The purpose of the invention is achieved with a vehicle wheelnut locking device that possesses the characteristics presented in the appended claims.

The locking device according to the invention is manufactured at least partly, from flexible material. There are several advantages when using flexible material: Flexible material stretches in use and when it is put in its place around the wheelnuts. This flexibility extends its using time. Furthermore this kind of locking device grips efficiently the nuts locking them so that they can not freely rotate. However one advantage is that when using flexible material the nuts can rotate or move slightly. This is important under hot temperatures when the wheelnuts became longer. When the wheelnuts can rotate slightly, the driver can see that there is a need to tighten the wheelnuts before there will be some problems.

The flexible material used is advantageously rubber, plastic or other similar material suitable for this purpose. The material can also be such that its colour will change when rotating. One embodiment is that the flexible material is from several material and there are two or more layers. It is also possible that the parts of the device are manufactured from one or more materials.

In the following, the invention is explained in more detail with reference to the attached illustrations, in which:

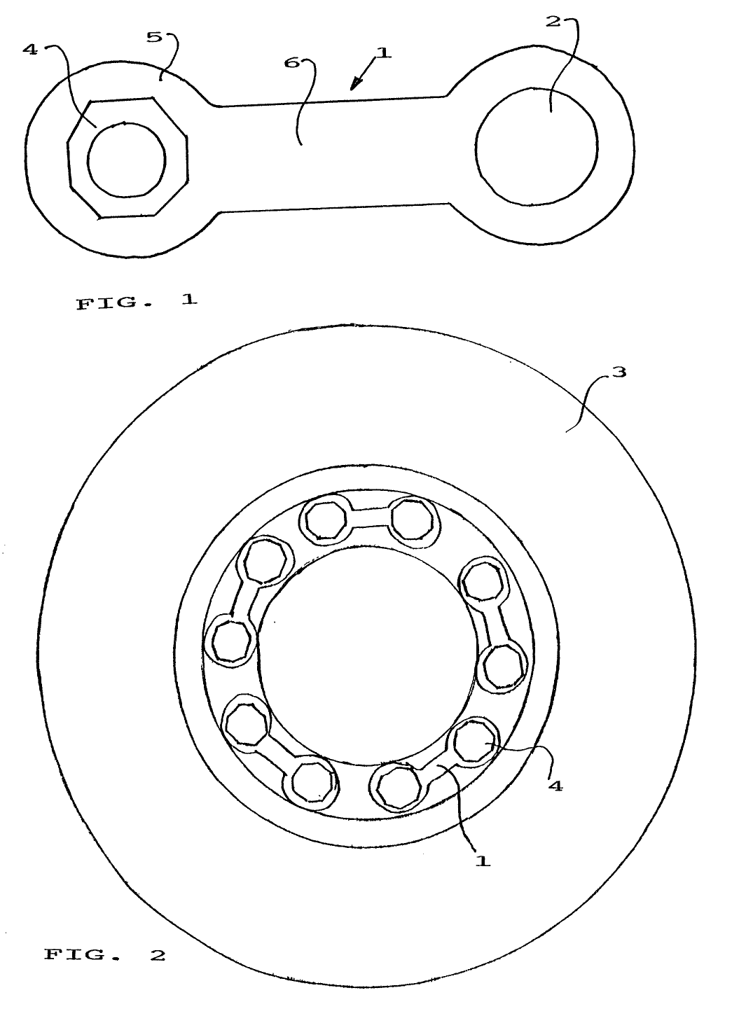

FIG. 1 shows an arrangement of the vehicle wheelnut locking device according to the invention, viewed from the side, and a nut locked in one of the holes, and

FIG. 2 shows a side view of a vehicle wheel which is fitted with a number of locking devices.

The locking device according to the arrangement shown in FIG. 1 comprises a plate or wedge type body 1, which includes two locking parts 5 and their centre section 6. There are holes 2 in the locking parts whose diameters are slightly smaller than the diameter of the wheelnuts on the vehicle wheel. In this arrangement the holes are mainly round. The distance between the holes 2 corresponds to the distance between the nuts. The locking device is manufactured from a flexible material and in this arrangement the material is rubber, which has been reinforced with fabric material. Other flexible material suitable for the purpose may also be used in various arrangements of the invention.

The locking devices according to FIG. 2 are positioned around the nuts 4 of the vehicle wheel 3 by placing them so that the holes of the locking device are over two adjacent nuts and then pressing the locking parts so that the holes slide down around the nuts. When the diameter of the holes is slightly smaller than the diameter of the nuts, the nuts are unable to rotate. The locking devices can be removed, for example, by pulling the centre section and the locking parts away from the wheel, then they come away relatively easily. Since the locking devices are made from flexible material, they can be reused several times.

In the other arrangements of the invention, locking devices can be used in which there are more than two holes and more than one centre section. Also in these arrangements the holes are the same distance part as the distance between the nuts, and by locking it you can lock as many nuts as there are holes in the locking device. It is also possible to manufacture locking devices which, instead of locking adjacent nuts, can be used to lock, for example, opposite nuts in place.

The invention is not limited to the advantageous arrangements shown but can vary within the framework of the invention concept formed by the claims.

1. A vehicle wheelnut locking device, which comprises
a body comprising two or more locking parts and one or more centre sections between the locking parts,
in locking parts are formed holes which are arranged to be positioned around the nuts of a wheel to prevent them rotating, and
the locking device is manufactured at least partly from a flexible material.

2. A vehicle wheelnut locking device, which device is manufactured at least partly from rubber.

3. A vehicle wheelnut locking device, which device is manufactured at least partly from plastic.
